(19) United States
(12) Patent Application Publication
(10) Pub. No.: US 2016/0303619 A1
(43) Pub. Date: Oct. 20, 2016

(54) Universal Aquarium Hose Cleaner

(71) Applicant: Denise Danzeisen, West Carrollton, OH (US)

(72) Inventor: Denise Danzeisen, West Carrollton, OH (US)

(21) Appl. No.: 15/130,592

(22) Filed: Apr. 15, 2016

Related U.S. Application Data
(63) Continuation-in-part of application No. 14/638,558, filed on Mar. 4, 2015, now abandoned.
(60) Provisional application No. 61/947,694, filed on Mar. 4, 2014.

(51) Int. Cl. B08B 9/04; A46B 9/02; A46B 3/18

(52) U.S. Cl. CPC B08B 9/04; A46B 3/18; A46B 9/026

(57) ABSTRACT

A universal aquarium hose cleaner is comprised of an elongated cylindrical brush affixed to the end of a semi-rigid cable or rigid wire, enabling the user to push the brush through the hose while twisting it to clean the interior surface of the hose. The wire or cable is coated with plastic to prevent corrosion.

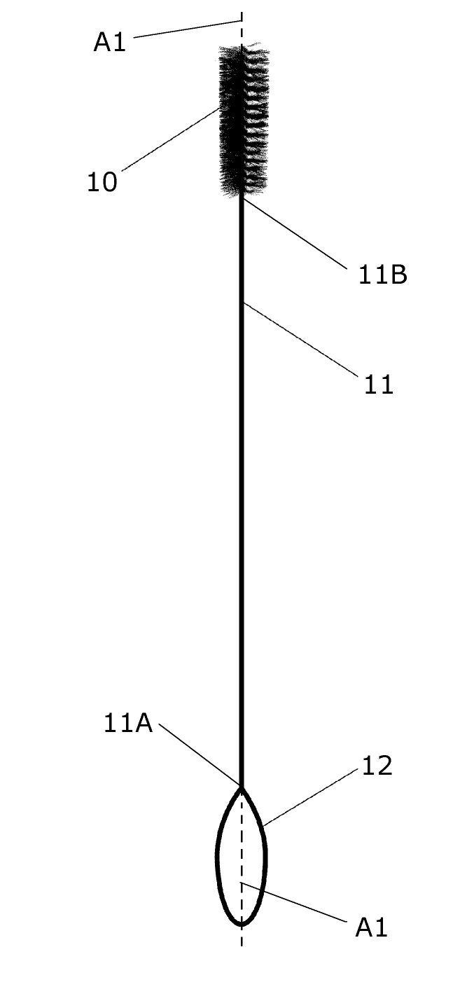

### CROSS-REFERENCE TO RELATED APPLICATIONS

This application claims the benefit of U.S. Provisional Application No. 61/947,694, filed Mar. 4, 2014, and U.S. application Ser. No. 14/638,558, filed Mar. 4, 2015 under 35 U.SC. 120, both of which are hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to aquarium equipment and accessories, and in particular to an elongated universal aquarium hose cleaner. Aquarium owners often find the chore of cleaning out the aquarium and related equipment to be tiresome. One of the items of equipment that is usually neglected is the hose leading from the aquarium to the external filter. Unfiltered water is constantly pumped through the hose every day, leaving a dirty residue which accumulates, and eventually may cause pump failure. If the hose can be kept clean, it will improve water flow and may extend the service life of the pump.

Existing brushes are not long enough to clean the long hoses used in modern aquariums. A significantly longer universal aquarium hose cleaner, with an elongated cylindrical brush attached to the end of a semi-rigid cable or rigid wire, would resolve this problem.

### SUMMARY OF THE INVENTION

Accordingly, the invention is directed to a significantly long universal aquarium hose cleaner. An elongated cylindrical brush is affixed to the end of a semi-rigid cable or rigid wire, enabling the user to push the brush through the hose while twisting it to clean the interior surface of the hose. The wire or cable is coated with plastic to prevent corrosion.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrate one embodiment of the invention and, together with the description, serves to explain the principles of the invention.

The FIGURE is a side view of the first exemplary embodiment, displaying the brush 10, the wire 11, the wire first end 11A, the wire second end 11B, the handle 12, and the axial line A1.

### DETAILED DESCRIPTION OF THE INVENTION

Referring now to the invention in more detail, the invention is directed to a universal aquarium hose cleaner. An elongated cylindrical brush 10 is affixed to the end of a semi-rigid cable or rigid wire 11, enabling the user to push the brush 10 through the hose while twisting it to clean the interior surface of the hose. The cable or wire 11 is coated with plastic to prevent corrosion.

The invention is preferably capable of being used on any hose, for example, a hose up to eight feet in length and one inch in diameter. The first exemplary embodiment comprises an elongated rigid wire 11, preferably eight feet long, having a first end 11A with a handle 12 affixed thereto, and a second end 11B having an elongated cylindrical brush 10, preferably one and one-quarter inches in diameter. The cylindrical brush 10 is preferably composed of equally spaced rings of bristles of equal radius, and not a spiral configuration. This configuration provides the most even distribution of bristles across the brush which allows for more even cleaning of the hose. The handle 12 is preferably an elongated elliptical loop and preferably lacks brush bristles. The wire 11 is centered about an axial line A1, which further is collinear with the major axis of the handle 12. The wire 11 is rigid such that the wire is unbendable. A rigid wire 11 which is unbendable would allow the universal aquarium hose cleaner to be pushed through an aquarium hose which is significantly long while still allowing the user to turn the brush 10 within the hose so that the hose can be cleaned.

The second exemplary embodiment is virtually identical to the first exemplary embodiment, except that the rigid wire 11 is replaced by a semi-rigid cable. The cable 11 is semi-rigid such that the cable is minimally bendable such that the brush 10 may be pulled through the hose while still allowing the user to rotate the brush 10 within the hose. Alternate embodiments, featuring cables or wires 11 of different lengths and gauges, and brushes 10 of different lengths and diameters, are also contemplated. Both of the exemplary embodiments may include brushes 10 of various lengths and diameters which are detachable and interchangeable.

It is to be understood that while the first and second exemplary embodiments are intended for use with an aquarium hose, this is not intended to be a limiting factor. The invention, manufactured in various sizes and lengths, may be used on any hose or pipe of significant length which must be cleaned out.

To use the first exemplary embodiment, the user must insert the brush 10 into one end of the hose, then hold the hose firmly with one hand, and the handle 12 with the other, and push the brush 10 through the hose to the other end using the handle 12, while twisting the handle 12. The user then rinses off the brush 10 and pulls the handle 12 to remove the device from the hose.

To use the second exemplary embodiment, the user must insert the handle 12 into one end of the hose, then hold the hose firmly with one hand, and the cable with the other, and gradually push the handle 12 through the hose to the other end using the cable. The user then rinses off the handle 12 and pulls the handle 12 while twisting to thoroughly clean the hose and pulling the brush 10 through the hose. The user then rinses off the brush 10 and the cable 11.

The brush 10 is preferably manufactured from a durable, flexible material, such as nylon, plastic, or natural bristles. The wire 11 is preferably manufactured from a rigid, durable material such as steel, aluminum alloy, or high-impact plastic. The cable is preferably manufactured from a semi-rigid, durable material such as a cable manufactured from steel or aluminum alloy. The handle 12 is preferably manufactured from a rigid, durable material such as steel, aluminum alloy, wood, or plastic. To prevent corrosion, all metal parts are preferably coated with a durable, waterproof material such as plastic or silicone.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An aquarium hose cleaner comprising a rigid wire such that said wire is unbendable; said wire having a first end and a second end; said wire being at least eight feet in length; a brush; said brush consisting of a plurality of equally spaced rings of bristles; said equally spaced rings of bristles being not in a spiral configuration such that each ring of bristles is separate from any other ring of bristles; said brush being affixed to said wire at said second end; a handle; said handle being affixed to said wire at said first end; and said handle lacking bristles.

2. The aquarium hose cleaner of claim 1 wherein said handle is elongatedly elliptically loop shaped.

3. The aquarium hose cleaner of claim 1 wherein said equally spaced rings of bristles are of equal radius.

4. The aquarium hose cleaner of claim 2 wherein said equally spaced rings of bristles are of equal radius.

5. The aquarium hose cleaner of claim 1 wherein said rigid wire and said handle are coated with a corrosion resistant material.

6. The aquarium hose cleaner of claim 2 wherein said rigid wire and said handle are coated with a corrosion resistant material.

7. The aquarium hose cleaner of claim 3 wherein said rigid wire and said handle are coated with a corrosion resistant material.

8. The aquarium hose cleaner of claim 4 wherein said rigid wire and said handle are coated with a corrosion resistant material.

9. The aquarium hose cleaner of claim 1 wherein said wire is centered about an axial line; said axial line being collinear with the major axis of said handle; and said equally spaced rings being centered about said axial line.

10. The aquarium hose cleaner of claim 2 wherein said wire is centered about an axial line; said axial line being collinear with the major axis of said handle; and said equally spaced rings being centered about said axial line.

11. An aquarium hose cleaner comprising a semi-rigid cable such that said cable is minimally bendable; said cable having a first end and a second end; said cable being at least eight feet in length; a brush; said brush consisting of a plurality of equally spaced rings of bristles; said equally spaced rings of bristles being not in a spiral configuration such that each ring of bristles is separate from any other ring of bristles; said brush being affixed to said cable at said second end; a handle; said handle being affixed to said cable at said first end; and
said handle lacking bristles.

12. The aquarium hose cleaner of claim 11 wherein said handle is elongatedly elliptically loop shaped.

13. The aquarium hose cleaner of claim 11 wherein said equally spaced rings of bristles are of equal radius.

14. The aquarium hose cleaner of claim 12 wherein said equally spaced rings of bristles are of equal radius.

15. The aquarium hose cleaner of claim 11 wherein said rigid cable and said handle are coated with a corrosion resistant material.

16. The aquarium hose cleaner of claim 12 wherein said rigid cable and said handle are coated with a corrosion resistant material.

17. The aquarium hose cleaner of claim 13 wherein said rigid cable and said handle are coated with a corrosion resistant material.

18. The aquarium hose cleaner of claim 14 wherein said rigid cable and said handle are coated with a corrosion resistant material.

19. The aquarium hose cleaner of claim 11 wherein said cable is centered about an axial line; said axial line being collinear with the major axis of said handle; and said equally spaced rings being centered about said axial line.

20. The aquarium hose cleaner of claim 12 wherein said cable is centered about an axial line; said axial line being collinear with the major axis of said handle; and said equally spaced rings being centered about said axial line.
